(19) United States
(12) Patent Application Publication
(10) Pub. No.: US 2024/0241056 A1
(43) Pub. Date: Jul. 18, 2024

(54) METHODS, SYSTEMS AND APPARATUS FOR A MULTI-SPECTRAL STRUCTURED ILLUMINATION MICROSCOPE

(71) Applicant: NanoString Technologies, Inc., Seattle, WA (US)

(72) Inventors: Evan Paul PERILLO, Woodinville, WA (US); Jaemyeong JUNG, Bellevue, WA (US); Dwayne DUNAWAY, Seattle, WA (US)

(21) Appl. No.: 18/686,012

(22) PCT Filed: Aug. 30, 2022
(86) PCT No.: PCT/US2022/075642

§ 371 Date: Feb. 23, 2024

Related U.S. Application Data
(60) Provisional application No. 63/238,418, filed on Aug. 30, 2021.

(51) Int. Cl. G01N 21/64

(52) U.S. Cl. CPC G01N 21/6486; G01N 21/6456; G01N 2021/6463

(57) ABSTRACT

In some embodiments, a system includes a light source configured to emit a first light beam having a first wavelength and a second light beam having a second wavelength. The system further includes an array mask having a set of apertures configured to change the first light beam to a first patterned light beam and change the second light beam to a second patterned light beam. The system includes a dispersion element configured to shift the first patterned light beam laterally based on the first wavelength and the second patterned light beam laterally based on the second wavelength. The system includes at least one sensor configured to detect first fluorescent radiation emitted from a sample excited by the first patterned light beam and second fluorescent radiation emitted from the sample excited by the second patterned light beam.

### RELATED APPLICATIONS

This application claims priority to, and the benefit of, U.S. Provisional Application No. 63/238,418, filed on Aug. 30, 2021. The contents of the aforementioned patent application are incorporated herein by reference in their entirety, for all purposes.

### TECHNICAL FIELD

Some embodiments described herein relate generally to microscopy. In particular, but not by way of limitation, some embodiments described herein relate to methods, systems and apparatus for a multi-spectral structured illumination microscope.

### BACKGROUND

Widefield microscopy and confocal microscopy are often used to study biological samples. These biological samples can be pre-treated with fluorescence labels and the widefield microscopy and confocal microscopy can take advantage of fluorescence contrast and study specific sub-cellular features of interests. It is challenging, however, for these technologies to reach the commercial targets of high plex (e.g., 3000 plex up to the Whole Transcriptome Atlas (WTA)) with a short turnaround time (e.g., less than 3 days/sample). Structured illumination microscopy (SIM) has been used to increase the 3-dimensional resolution of a microscope. Known SIM techniques, however, require multiple exposures to be acquired for every frame and every color channel, which reduces the acquisition speed and therefore results in a low overall throughput.

Thus, a need exists for a structured illumination microscope that produces high-resolution images at a high imaging speed to increase the overall throughput.

### SUMMARY

In some embodiments, a system includes a light source configured to emit a first light beam having a first wavelength and a second light beam having a second wavelength. The system further includes an array mask having a set of apertures configured to change the first light beam to a first patterned light beam and change the second light beam to a second patterned light beam. The system includes a dispersion element configured to shift the first patterned light beam laterally based on the first wavelength and the second patterned light beam laterally based on the second wavelength. The system includes at least one sensor configured to detect first fluorescent radiation emitted from a sample excited by the first patterned light beam and second fluorescent radiation emitted from the sample excited by the second patterned light beam.

### DETAILED DESCRIPTION OF THE DRAWINGS

The above and further features will be more clearly appreciated from the following detailed description when taken in conjunction with the accompanying drawings.

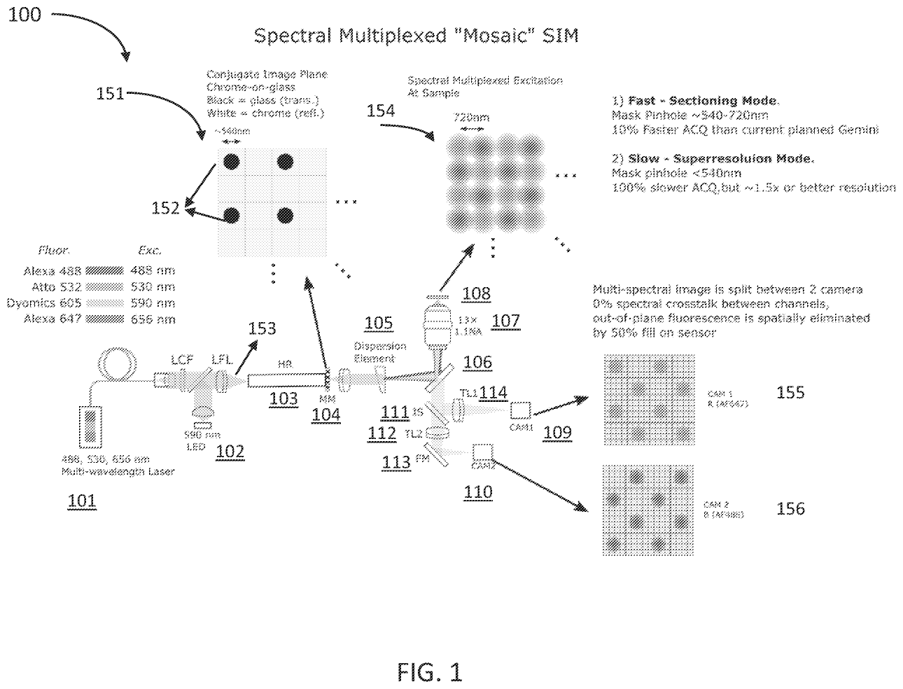

FIG. 1 illustrates a schematic diagram of a mosaic structured illumination microscope (SIM) system, according to some embodiments.

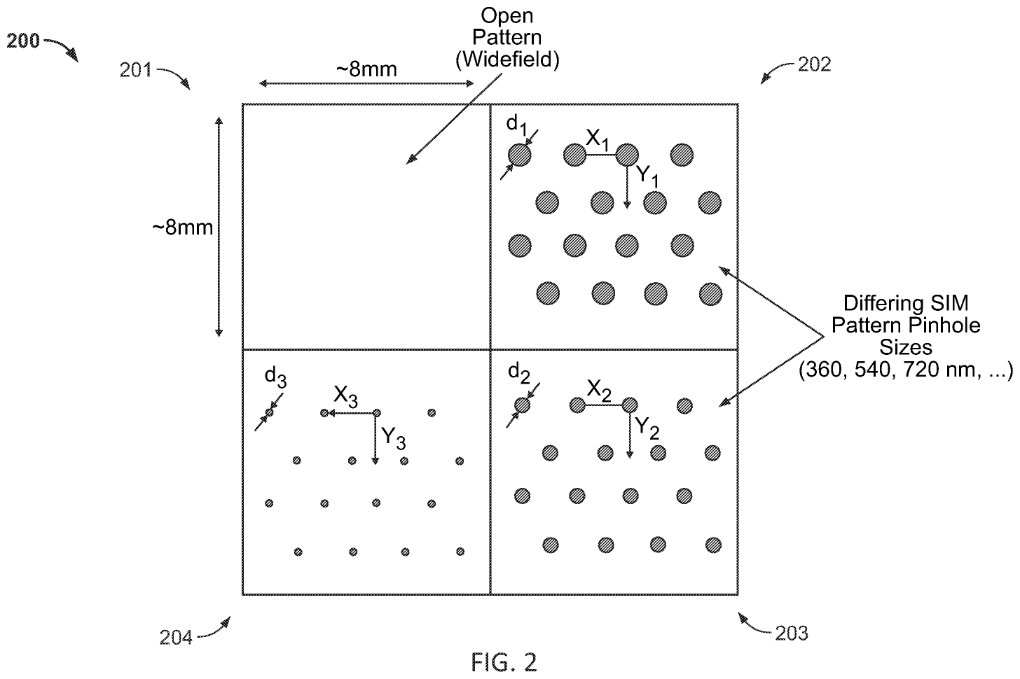

FIG. 2 illustrates an example array mask in a mosaic SIM system, according to some embodiments.

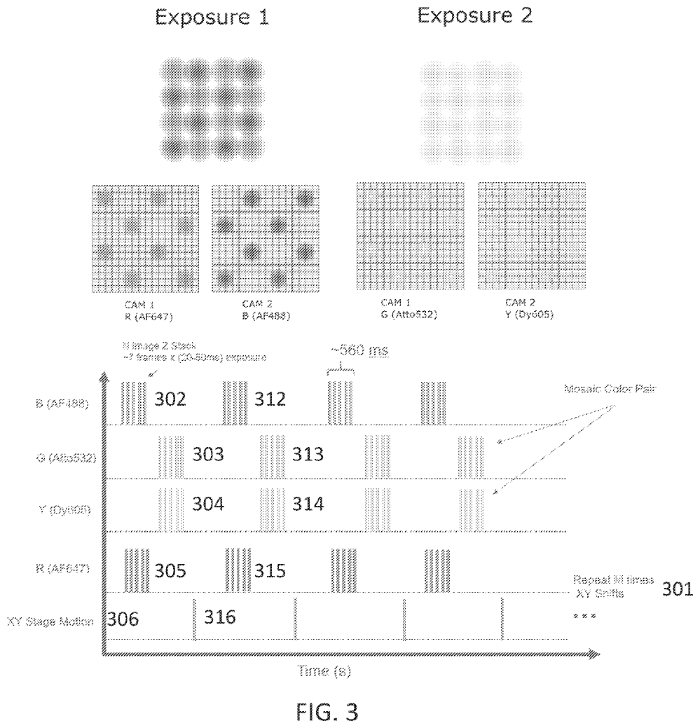

FIG. 3 illustrates an example exposure sequence using the mosaic SIM system, according to some embodiments.

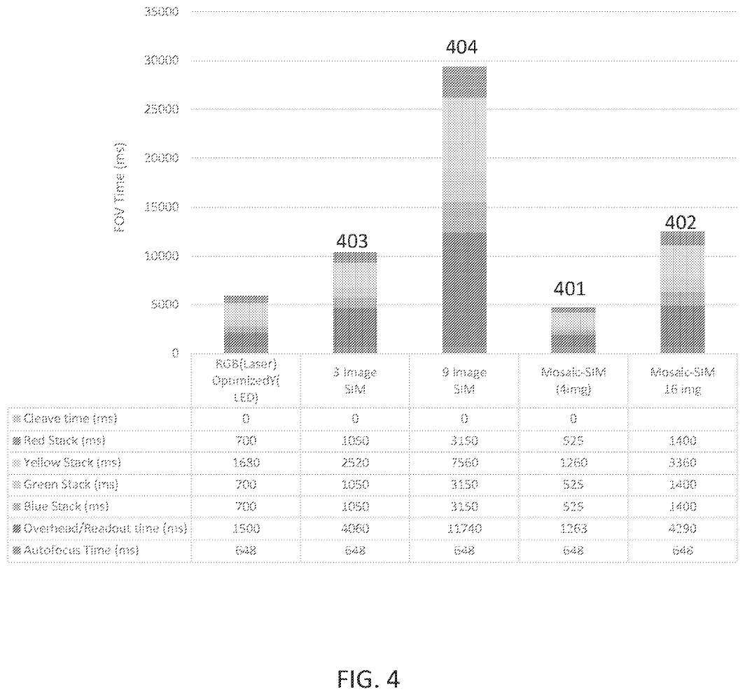

FIG. 4 is a chart comparing example imaging speeds of the mosaic SIM system and the traditional SIM system, according to some embodiments.

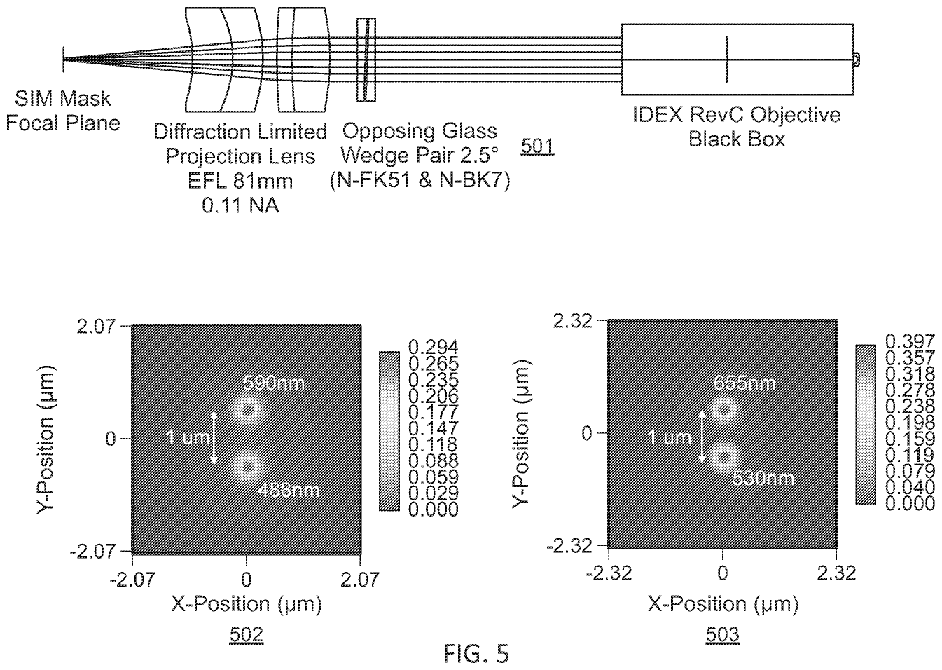

FIG. 5 illustrates a simulation result of using the dispersion element to generate multi-spectral mosaic grids of light beams, according to some embodiments.

### DETAILED DESCRIPTION

Embodiments described herein include methods, systems, and apparatus that significantly increase the imaging speed of a structured illumination microscope (SIM) using a spectrally multiplexed excitation grid (also referred to as “mosaic excitation”). The mosaic SIM described herein allows simultaneous imaging using a light source having multiple colors (or multiple light sources having multiple colors) and effectively parallelizes the imaging process. In some implementations, the mosaic SIM described herein can achieve around twice higher 3D resolving capability and a 20% faster imaging rate when compared to standard widefield fluorescence microscopy. In some implementations, the mosaic SIM described herein can achieve up to three times faster than the traditional multifocal SIM approach, achieving the same 3D resolution. The mosaic SIM described herein can be beneficial to any applications requiring high speed, high resolution fluorescence imaging in specimen such as 5 μm thick FFPE, Fresh-frozen, or live tissue.

Embodiments described herein include a microscope design that provides optical sectioning and super-resolution by multispectral patterned illumination at the sample plane, and demultiplexed readout on two cameras. In some implementations, the mosaic SIM described herein can improve the technologies in the super-resolution imaging (e.g., multifocal SIM, or image scanning microscopy) by offering large field-of-view imaging of, for example, up to four fluorophores through spectral multiplexing. In some implementations, the mosaic excitation grid can be effectively utilized with fluorophores of non-overlapping excitation and emission spectra. In some implementations, the mosaic SIM can achieve the data capture rate of about 4.5 E+06 voxel/second and the number of resolvable features of 3.5 emitters/objects per cubic micron. A voxel can be defined as a 3D pixel with dimensions determined by the resolution of the imaging system.

As used herein, the singular forms “a,” “an” and “the” include plural referents unless the context clearly dictates otherwise. Thus, for example, the term “a light source” is intended to mean a single light source or multiple light sources with similar functionalities.

FIG. 1 illustrates a schematic diagram of a mosaic structured illumination microscope (SIM) system, according to some embodiments. In some embodiments, the mosaic SIM system 100 includes a first light source 101, a second light source 102, a homogenizing rod (HR) 103, an array mask (MM) 104, a dispersion element 105, a polychroic filter 106, an objective lens 107, a first sensor (or a first photo detector) 109, and a second sensor (or a second photo detector) 110. In some implementations, the mosaic SIM system can include a single light source (e.g., 101) or multiple light sources. In some implementations, the mosaic SIM system can include a single sensor (e.g., 109) or multiple sensors. The mosaic SIM system 100 can be configured to capture high-resolution fluorescent images of a sample 108. The sample 108 can be any biological or non-biological samples that can be fluorescently stained. For example, the sample 108 can include, but are not limited to, a live tissue sample, a FFPE tissue sample, a fresh frozen tissue sample, a mono layer cell, a cultured cell, engineered tumors, clustered of cells, tissue, and/or the like. In some implementations, the sample 108 can have up to 100 micron meters in thickness.

In some implementations, the first light source 101 can be a laser emitting light at multiple wavelengths (e.g., blue light at a wavelength of 488 nm, green light at a wavelength of 530 nm, a red light at a wavelength of 656 nm). In some implementations, the mosaic SIM system 100 can include the second light source 102 emitting light at a single wavelength (e.g., yellow light at a wavelength of 590 nm) or multiple wavelengths. In some implementations, the first light source 101 and the second light source 102 can emit light at the same time or at different times.

In some implementations, the mosaic SIM system 100 can include a homogenizing rod (HR) 103 configured to homogenize the light beams emitted from the first light source 101 and/or the second light source 102 to create a light beam with a nearly constant optical intensity over some area and negligible intensity outside that area.

In some implementations, the mosaic SIM system 100 can include an array mask (MM) 104 having a set of apertures (or pinholes) configured to change the light beam to a patterned light beam. In some implementations, the array mask 104 can be configured to be disposed near an optically conjugated position of the sample 108 (e.g., when critical illumination is used). In some implementations, the array mask 104 can be configured to be disposed near an optically conjugated position to a focal plane of the objective lens 107 disposed in an illumination path of the patterned light beam.

In some implementations, the homogenizing rod 103 can be disposed between the light source 101 or 102 and the array mask 104. In some implementations, the array mask 104 can be disposed proximate to the homogenizing rod 103 and not attached to the homogenizing rod 103. In other implementations, the array mask 104 can be a layer of material that is coated to the homogenizing rod 103 and thus the array mask 104 and the homogenizing rod 103 are a single element. In yet other implementations, the array mask 104 can be a stand-alone mask (e.g., chrome-on-glass) and attached to the homogenizing rod 103. In some implementations, the array mask 104 can be movable via, for example, a translation stage (e.g., a high precision linear XY translation stage; not shown in FIG. 1). The array mask 104 can be disposed in near proximity with the homogenizing rod 103 and the translation stage can move the array mask such that the light beam output from the homogenizing rod 103 can be moved in and out of optimal focus. In these implementations, the movable array mask 104 can be disposed near an optically conjugated position to the focal plane of the sensor 109 or 110.

As shown in FIG. 1, diagram 151 is an example array mask 104 viewed from the perspective of the light path 153. In this example, the array mask 104 can be made of glass. The array mask 104 can include the set of apertures 152 made of glass to transmit the light beam. The area outside of the set of apertures 152 of the array mask 104 can be made of (or coated with) chrome to reflect the light beam. In other words, the light beam can only pass through the set of apertures 152 and from a grid of light beam (or an excitation grid, or a patterned light beam). In some implementations, the size of the set of apertures 152 and the spacings between the apertures 152 can vary. In some implementations, the array mask 104 can include multiple sets of apertures and each set from the multiple sets of apertures can include apertures that have different sizes and spacings, as shown in FIG. 2.

FIG. 2 illustrates an example array mask in a mosaic SIM system, according to some embodiments. In some embodiments, an array mask 200 (similar to the array mask 104 in FIG. 1) can include multiple areas 201-204 and each area (e.g., 8 mm×8 mm) can have the same or different arrangements of the apertures. In these embodiments, the mosaic SIM system (e.g., 100 in FIG. 1) can obtain images of samples with different resolution by using the array mask 200 having different aperture sizes.

For example, the first area 201 of the array mask 200 can have an open pattern (or widefield). In other words, the light beam can pass through the first area 201 with no or minimum blocking. The second area 202 of the array mask 200 can have a first set of apertures having a first size (e.g., 720 nm in the sample plane), a first horizontal spacing between each two apertures from the first set of apertures, and a first vertical spacing between each two apertures from the first set of apertures. The third area 203 of the array mask 200 can have a second set of apertures having a second size (e.g., 540 nm), a second horizontal spacing between each two apertures from the second set of apertures, and a second vertical spacing between each two apertures from the second set of apertures. The fourth area 204 of the array mask 200 can have a third set of apertures having a third size (e.g., 360 nm), a third horizontal spacing between each two apertures from the third set of apertures, and a third vertical spacing between each two apertures from the third set of apertures.

In some implementations, an array mask with smaller-sized apertures can enable super-resolution imaging capability (sub-diffraction limited resolution). In some implementations, when the diameter of the aperture is smaller than the optical resolution limit (˜720 nm in the sample plane), the reconstruction of a higher resolution image captured using the mosaic SIM system (e.g., 100 in FIG. 1) can be achieved. For example, the frequency pass bandwidths of the optical transfer function (OTF) can be increased by a factor of, for example, up to two-fold by aggregating multiple views of a single illumination object. For another example, the mosaic SIM system can be configured to capture multiple spatially offset samples/measurements of the same point spread function on an area detector and process using an arithmetic transform developed from principles founded in scalar diffraction theory and Fourier optics. In some implementations, the mosaic SIM system (e.g., 100 in FIG. 1) can obtain a full 2× increase in resolution using an array mask having an aperture size of about 100 nm-300 nm in diameter. In some implementations, the mosaic SIM system (e.g., 100 in FIG. 1) can perform tens of sub-exposures steps per frame to obtain the higher resolution images.

Table 1 shows an example range of potential aperture sizes at sample plane with two example objective lens (1.1NA & 1.4NA). These aperture sizes refer to the projected illumination size at the sample focal plane, not the aperture sizes measured from the array mask. The physical aperture size and aperture pitch size can be larger, in some implementations, depending on the magnification of the optical elements. The magnification of the optical elements can be, for example in the range of −10×. In other words, an aperture size of 532 nm (in the sample focal plane) as shown in Table 1 below can be 5.32 μm measured from the array mask. In some implementations, Airy Disk refers to the smallest diffraction limited feature that can be attained for a given optical system. Pinhole Pitch refers to pinhole spacing, or regular spacing of elements in a grid or array pattern.

TABLE 1

| | Airy | | | | | | |
|---|---|---|---|---|---|---|---|
| | Disk | Sectioning Mode (Fast Imaging Mode) | | | | | |
| | Diameter | pinhole | | pinhole | | Number Sub- | |
| | (nm) | size | | pitch | | Frame Images | |
| | 1.22 lambda | (nm) | | (nm) | | Required | |
| | (/NA) | low | high | low | high | low | high |
| 1.1 NA Objective | 665 | 532 | 798 | 1500 | 2250 | 2 | 4 |
| 1.4 NA Objective | 522 | 418 | 626 | 1178 | 1766 | 12 | 4 |
| Percentage Relative | 100% | 80% | 120% | 160% | 240% | | |
| to Airy Disk Size | | | | | | | |

| | Super-resolution Mode (Slow Imaging Mode) | | | | | |
|---|---|---|---|---|---|---|
| | pinhole | | pinhole | | Number Sub- | |
| | size | | pitch | | Frame Images | |
| | (nm) | | (nm) | | Required | |
| | low | high | low | high | low | high |
| 1.1 NA Objective | 166 | 333 | 1500 | 2250 | 8 | 32 |
| 1.4 NA Objective | 131 | 261 | 1178 | 1766 | 8 | 32 |
| Percentage Relative | 25% | 50% | 160% | 240% | | |
| to Airy Disk Size | | | | | | |

In some implementations, the array mask 200 can be operatively coupled to an XY translation stage (not shown). The XY translation stage can shift the array mask 200 such that different areas 201-204 of the array mask 200 (having different aperture sizes) are on the light path (e.g., 153 in FIG. 1) or aligned with the homogenizing rod (103 in FIG. 1). For example, the XY translation stage can shift the array mask 200 such that the light beam output from the homogenizing rod (103 in FIG. 1) passes though the open pattern 201 that allows widefield excitation. The XY translation stage can shift the array mask 200 to areas with reduced aperture sizes (e.g., 203 or 204) that, in some implementations, allows optical sectioning (540-720 nm) down to 2D super-resolution imaging (˜100-300 nm). In some implementations, a large motion (˜8 mm) of the XY translation stage can be used to shift the array mask 200 to different areas 201-204. In some implementations, the light rod (e.g., the light rod that is attached to other optical elements including the homogenizing rod 103, the dispersion element 105, and/or the like) and other optical elements can remain stationary.

Returning to FIG. 1, in some implementations, the mosaic SIM system 100 can include the dispersion element 105 that receives the light beam output from the array mask 104 and shifts the grid of light beam (or the excitation grid) laterally depending on the wavelength of the light beam. The light beam that passes through the dispersion element 105 can form the mosaic grid of the light beam (or a checked pattern of the light beam). For example, a light source 101 emits a first light beam having a first wavelength (e.g., a red light beam) and a second light beam having a second wavelength (e.g., a blue light beam). The first light beam and the second light beam passes through a set of optical elements, including, for example, the homogenizing rod 103, the array mask 104 having a set of apertures 152, the dispersion element 105, the polychroic filter 106 (or a multi-edge dichroic filter which reflects the light beam), and the objective lens 107 and illuminates the sample 108. The array mask 104 having the set of apertures 152 can change the first light beam to a first patterned light beam and change the second light beam to a second patterned light beam. The dispersion element 105 can shift the first patterned light beam laterally based on the first wavelength and the second patterned light beam laterally based on the second wavelength and form a mosaic grid of the first light beam and the second light beam (or a checked pattern of the red light beam and the blue light beam 154). When the light source 101 or 102 emits a third light beam having a third wavelength (e.g., a green light beam) and a fourth light beam having a second wavelength (e.g., a yellow light beam), a mosaic grid of the third light beam and the fourth light beam (or a checked pattern of the green light beam and the yellow light beam) can illuminate the sample 108.

In some implementations, the dispersion element 105 can be a passive dispersion element such as a glass wedge having a first side and a second side and the first side and the second side forming an angle. In some implementations, the angle formed by the first side and the second side can be pre-determined or adjustable. In some implementations, the dispersion element 105 can include a glass wedge having a pre-determined refractive index. In some implementations, the dispersion element 105 can be any optical element that shifts light beams based on the wavelengths associated with the light beams. For example, the dispersion element can include a grating, a diffraction grating, a prism, or a glass wedge with any shape. In some implementations, the dispersion element 105 can include two glass wedges with two refractive index which shifts the light beams at a pre-determined distance.

In response to being illuminated with the mosaic grid of the light beams having multiple wavelengths, the sample, pre-treated with fluorescence labels, can emit fluorescent radiation. In some implementations, the fluorescent radiation can transmit through the polychroic filter 106 onto a dichroic image splitter (IS) 111 (also referred to as beam splitter) which can separate fluorescent radiation, based on the wavelength, onto a first sensor 109 and a second sensor 110. The first sensor 109 and the second sensor 110 can each detect the fluorescent radiation, respectively. For example, in response to being illuminated with the mosaic grid of the first light beam having the first wavelength (e.g., the red light beam) and the second light beam having the second wavelength (e.g., the blue light beam), the sample can emit first fluorescent radiation having the first wavelength and second fluorescent radiation having the second wavelength. The first fluorescent radiation and the second fluorescent radiation can pass through the dichroic image splitter 111 which separate the first fluorescent radiation to the first sensor 109 and the second fluorescent radiation to the second sensor 110. The first sensor can detect the first fluorescent radiation 155 and the second sensor can detect the second fluorescent radiation 156.

In some implementations, an electronic device (not shown) having a processor and a memory can be operatively coupled to the first sensor 109 and the second sensor 110. The electronic device can form an image of a region of the sample 108 based on the first fluorescent radiation and the second fluorescent radiation.

In some implementations, the benefits of the mosaic SIM system 100 having two sensors 109 and 110 include zero spectral crosstalk between channels. Additionally, out-of-plane fluorescence can be spatially eliminated by 50% fill on sensors 109 or 110.

In some implementations, the mosaic SIM system 100 can include a single sensor 109 or 110. In these implementations, the dispersion element 105 can shift light beams having multiple wavelengths laterally such that each light beam having a single wavelength illuminates at a different location onto the sample 108. In response to being illuminated with the mosaic grid of the light beams having multiple wavelengths, the sample emits fluorescent radiation. When the single sensor detects the fluorescent radiation, different regions of the single sensor can receive fluorescent radiation with different wavelengths. Thus, the single sensor can form the image of a region of the sample 108.

In some implementations, the mosaic SIM system 100 can include a set of sensors (e.g., more than two sensors 109 and 110). For example, when light beams having a set of wavelengths pass through the array mask 104 and the dispersion element 105, the light beams can be shifted laterally onto the sample 108. A set of fluorescent radiation can be emitted from the sample 108 and split by an image splitter 111 to the set of sensors. Each sensor from the set of sensors can detect an image of the fluorescent radiation having a single wavelength or a subset of the set of wavelengths.

In some implementations, when the mosaic SIM system 100 includes a first sensor 109 and a second sensor 110, the first sensor 109 can capture first fluorescent radiation (having the first wavelength) and the second sensor 110 can capture second fluorescent radiation (having the second wavelength) simultaneously (or, in some implementations, sequentially). In other words, a single frame exposure, collected simultaneously for a given color pair by the first sensor 109 and the second sensor 110, respectively, can include two sub-frames (or multiple sub-frames by multiple sensors). In some implementations, when the array mask 104 is moved by a distance (e.g., by a translational XY stage), the light beams can be illuminated onto a different region of the sample 108. As a result, the first sensor 109 can capture third fluorescent radiation (having the first wavelength) and the second sensor 110 capture fourth fluorescent radiation (having the second wavelength) simultaneously. In some implementations, for the fast imaging mode, two sub-frame exposures can be captured to generate a full frame with a pinhole spacing of 720 nm (in the sample space) and pinhole size of 540-720 nm (in the sample space). When using a magnification at the array mask plane of 7.5, for example, for a desired 720 nm shift in sample space the resulting shift can be 5.4 μm in the array mask space. This magnitude of shift can be achieved with high resolution linear or piezo stages. Stated differently, once the first sensor captures the first fluorescent radiation and the second sensor captures the second fluorescent radiation, the translational XY stage can move the array mask 104 from a first position to a second position by a distance of, for example, 5.4 μm. As a result, the light beams illuminated on the sample 108 can be shifted by a distance of 720 nm in the XY plane. At the second position, the first sensor can capture the third fluorescent radiation and the second sensor can capture the fourth fluorescent radiation. The first fluorescent radiation and the third fluorescent radiation collectively provide a full frame of a fluorescent image of the sample illuminated with a light beam having the first wavelength. Similarly, the second fluorescent radiation and the fourth fluorescent radiation collectively provide a full frame of a fluorescent image of the sample illuminated with a light beam having the second wavelength.

In some implementations, the mosaic SIM system 100 can be operated in a slow imaging and high-resolution mode. In this mode, the mosaic SIM system 100 can use the array mask 104 having apertures with a size smaller than the apertures of the array mask 104 in the fast imaging mode discussed above. For example, when the size of the aperture is less than, for example, 540 nm (in the sample space), the mosaic SIM system 100 can take more than two exposures (thus, longer time in some examples) to capture a full frame of the fluorescent image of the sample. The image resolution in the slow imaging mode can be higher than that in the fast imaging mode, in some examples.

FIG. 3 illustrates an example exposure sequence using the mosaic SIM system, according to some embodiments. In some examples, the mosaic SIM system (e.g., the mosaic SIM system 100 in FIG. 1) can capture a sequence of images having a number of N frames by shifting the array mask in the XY plane a number of M times 301. In other words, each frame from the number of N frames has a number of M images by shifting the array mask in the XY plane a number of M times. Each frame from the number of N frames is taken of the sample when the objective lens 107 is focused at a different depth of the sample in the Z direction. Thus, the number of N frames can depend on the sample thickness and can be, in some examples, in the range of 7-8 frames. The number of M shifts can depend on the size of the apertures in the array mask 104 and can be as small as 2 for optical sectioning, or as large as around 32 for a high resolution 2× lateral resolution enhancement image.

As shown in FIG. 3, in some implementations, when the array mask is at a first position 306, the first sensor of the mosaic SIM system can capture a first fluorescent image having a first wavelength 302 and the second sensor of the mosaic SIM system can capture a second fluorescent image having a second wavelength 305 simultaneously. The mosaic SIM system can change the distance between the objective lens and sample to adjust the focus depth in the Z direction of the sample and capture a number of N images (multiple blue lines 302 and multiple red lines 305). When the array mask is still at the first position 306, the mosaic SIM system can change light beam such that light beams having a third wavelength and a fourth wavelength can pass through. The first sensor can then capture a third fluorescent image having the third wavelength 303 and the second sensor can capture the fourth fluorescent image having the fourth wavelength 304 simultaneously. The mosaic SIM system can again change the distance between the objective lens and sample to adjust the focus depth in the Z direction of the sample and capture a number of N images (multiple green lines 303 and multiple yellow lines 304). Subsequently, a translational XY stage can move the array mask to a second position 316. The first sensor of the mosaic SIM system can capture a fifth fluorescent image having a first wavelength 312 and the second sensor of the mosaic SIM system can capture a sixth fluorescent image having a second wavelength 315 simultaneously. The mosaic SIM system can change the distance between the objective lens and sample to adjust the focus depth in the Z direction of the sample and capture a number of N images (multiple blue lines 312 and multiple red lines 315). When the array mask is still at the second position 316, the mosaic SIM system can change light beam such that light beams having a third wavelength and a fourth wavelength can pass through. The first sensor can then capture a seventh fluorescent image having the third wavelength 313 and the second sensor can capture the eighth fluorescent image having the fourth wavelength 314 simultaneously. The mosaic SIM system can again change the distance between the objective lens and sample to adjust the focus depth in the Z direction of the sample and capture a number of N images (multiple green lines 313 and multiple yellow lines 314). The process can repeat when the array mask is shifted to different positions 301.

FIG. 4 is a chart comparing example imaging speeds of the mosaic SIM system and the traditional SIM system, according to some embodiments. For example, the projected timing stack-up for a full sequence of exposures in a single field of view is shorter for the mosaic SIM system 401 and 402, compared with known SIM systems 403 and 404. In some examples, the mosaic SIM system includes the imaging speed by a factor of two.

FIG. 5 illustrates a simulation result of using the dispersion element to generate multi-spectral mosaic grids of light beams, according to some embodiments. In some embodiments, the mosaic SIM system can include a dispersion element having an opposing glass wedge pair 501 with, for example, a tilt angle of 2.5 degrees. The dispersion element can provide the chromatic displacement of the excitation pairs (488, 590 nm) and (530, 655 nm). In other words, as discussed with regards to the dispersion element 105 in FIG. 1, the dispersion element can shift light beams having different wavelengths laterally based on the wavelengths. For light beams having wavelengths of 488 nm and 590 nm, the dispersion element 501 can shift the light laterally (or provide the chromatic displacement.) Similarly, for light beams having wavelengths of 530 nm and 655 nm, the dispersion element 501 can also shift the light laterally (or provide the chromatic displacement.)

In some implementations, the dispersion element having the opposing glass wedge pair 501 can reduce or minimize beam deflection and “walk-off” from changes in index of refraction of the optical elements. In other words, the difference in index of refraction between different excitation wavelengths (or dispersion) can cause the illumination pattern to shift laterally by a known and repeatable amount in the image plane. Beam “walk-off” can refer to the situation where the illumination light is directed by angles differently through the optical system such that light is clipped by limiting apertures within the system and power can be lost. Thus, a glass wedge pair (or a dispersion element having the opposing glass wedge pair) can reduce the beam “walk-off” while still introducing an effective amount of dispersion. In some implementations, the dispersion element can have a single glass wedge which can create, in some examples, several millimeters of lateral beam displacement.

The simulation results show that using the dispersion element 501, the lateral shift (or the lateral chromatic displacement) of the light beams having two different wavelengths can be about 1 μm (in the image plane or the sample plane) for the both beam pairs (i.e., light beam pair 502 having wavelengths of 488 nm and 590 nm and the light beam pair 503 having wavelengths of 530 nm and 655 nm).

In some embodiments, the mosaic SIM system discussed herein can increase image capturing rate as well as improving fluorescence signal contrast in 3-D samples compared with the known widefield microscope. The mosaic SIM system can be configured to be operated in a fast imaging mode or a slow imaging mode. In some implementations the emitter densities can achieve 3/μm³ in the fast imaging mode. In the slow imaging mode, the mosaic SIM system can record images with super-resolution (e.g., sub-diffraction limited) that allow emitter densities up to 6/μm³. As a result, the mosaic SIM system enables deeper tissue investigation. For example, tissues having a thickness of 10 μm can be imaged with no loss in optical performance using the mosaic SIM system. The mosaic SIM system can be used for imaging-based spatial transcriptomics.

What is claimed is:

1. A system, comprising:
a light source configured to emit a first light beam having a first wavelength and a second light beam having a second wavelength;
an array mask having a set of apertures configured to change the first light beam to a first patterned light beam and change the second light beam to a second patterned light beam;
a dispersion element configured to shift the first patterned light beam laterally based on the first wavelength and the second patterned light beam laterally based on the second wavelength; and
at least one sensor configured to detect first fluorescent radiation emitted from a sample excited by the first patterned light beam and second fluorescent radiation emitted from the sample excited by the second patterned light beam.

2. The system of claim 1, wherein:
the dispersion element includes a glass wedge having a first side and a second side, the first side and the second side forming a pre-determined angle.

3. The system of claim 1, wherein:
the dispersion element includes a glass wedge having a first side and a second side, the first side and the second side forming an adjustable angle.

4. The system of claim 1, wherein:
the dispersion element includes a glass wedge having a pre-determined refractive index.

5. The system of claim 1, wherein:
the array mask is configured to be disposed near an optically conjugated position of the sample.

6. The system of claim 1, wherein:
the array mask is configured to be disposed near an optically conjugated position to a focal plane of an objective lens disposed in an illumination path of the first patterned light beam and the second patterned light beam.

7. The system of claim 1, wherein:
the first light beam and the second light beam transmit through the set of apertures of the array mask;
the first light beam and the second light beam reflect from a remaining area of the array mask.

8. The system of claim 1, further comprising:
a translation stage configured to move the array mask.

9. The system of claim 1, further comprising:
a homogenizing rod configured to be disposed between the light source and the array mask and configured to homogenize the first light beam;
the array mask is configured to be attached to the homogenizing rod.

10. The system of claim 1, further comprising:
a homogenizing rod configured to be disposed between the light source and the array mask and configured to homogenize the first light beam;
the array mask is configured to be disposed proximate to the homogenizing rod and not attached to the homogenizing rod.

11. The system of claim 1, wherein:
the at least one sensor includes a first photo detector configured to detect the first fluorescent radiation and a second photo detector configured to detect the second fluorescent radiation.

12. The system of claim 1, wherein:
the array mask is configured to be moveable from a first position to a second position causing the first patterned light beam to shift from a third position to a fourth position;
the at least one sensor is configured to detect third fluorescent radiation emitted from the sample excited by the first patterned light beam at the fourth position, the first fluorescent radiation and the third fluorescent radiation combined providing a fluorescence image of a field of view of a portion of the sample.

13. The system of claim 1, wherein:
the array mask includes multiple sets of apertures, apertures from a first set of apertures from the multiple sets of apertures having sizes or spacings different from apertures from a second set of apertures from the multiple sets of apertures.

14. The system of claim 1, wherein:
the sample includes one of a live tissue sample, a FFPE tissue sample, or a fresh frozen tissue sample.

15. The system of claim 1, further comprising:
a beam splitter configured to split fluorescent radiation into the first fluorescent radiation and the second fluorescent radiation.

16. The system of claim 1, wherein:
the at least one sensor is a single sensor configured to detect the first fluorescent radiation and the second fluorescent radiation.

17. A method, comprising:
illuminating a biological sample with a first patterned light beam having a first wavelength at a first time and a second patterned light beam having a second wavelength at a second time after the first time, the first patterned light beam and the second patterned light beam formed by an array mask having a set of apertures having at least one pre-determined size and at least one pre-determined spacing between the set of apertures, the first patterned light beam and the second patterned light beam dispersed laterally by a dispersion element based on the first wavelength and the second wavelength; and
detecting first fluorescent radiation emitted from the biological sample and second fluorescent radiation emitted from the biological sample to generate an image of at least a portion of the biological sample.
